(19) United States
(12) Patent Application Publication
(10) Pub. No.: US 2024/0250414 A1
(43) Pub. Date: Jul. 25, 2024

(54) HANDLE FOR A CAR DOOR COMPRISING A NEAR FIELD COMMUNICATION UNIT

(71) Applicant: MINEBEA ACCESSSOLUTIONS ITALIA S.P.A., Pianezza (IT)

(72) Inventors: Anthony GUERIN, Pianezza (IT); Antonio ROCCI, Pianezza (IT); Marco SAVANT, Pianezza (IT)

(73) Assignee: MINEBEA ACCESSSOLUTIONS ITALIA S.P.A., Pianezza (IT)

(21) Appl. No.: 18/421,219

(22) Filed: Jan. 24, 2024

(30) Foreign Application Priority Data
Jan. 24, 2023 (EP) 23152999.1

(51) Int. Cl. H01Q 1/32; E05B 77/32; E05B 79/06; H01Q 23/00

(52) U.S. Cl. CPC H01Q 1/3241; E05B 77/32; E05B 79/06; H01Q 1/3283; H01Q 23/00

(57) ABSTRACT

A handle for a car door includes a near field communication unit having a microchip and an antenna. The antenna includes a coil and an elongated connection part configured to cooperate with the microchip, a body, an overmolded portion formed on the body and defining an encapsulating zone including an entirety of the coil and part of the elongated connection part. The elongated connection part includes a terminal portion including a cooperation extremity configured to cooperate with the microchip. The terminal portion is outside the encapsulated zone.

### CROSS-REFERENCE TO RELATED APPLICATIONS

This application claims priority to and the benefit of Europe application Ser. No. 23/152,999.1 filed on Jan. 24, 2023. The disclosures of the above applications are incorporated herein by reference.

### FIELD

The present disclosure relates to a handle for a car door including a near field communication unit.

### BACKGROUND

The statements in this section merely provide background information related to the present disclosure and may not constitute prior art.

It is known to have a handle for a car door that can be actuated by an electric device for locking, unlocking or opening the door. There is a need to have a sensor or communication device on or near the handle to facilitate the actuation.

It is also known to design the handle according to several shapes extending externally from the car door. It engenders a protruding part that can be grabbed by a user.

This protruding part can, for example, present a wing form starting from the car door with a transverse portion, an elbow portion, and a terminal portion extending obliquely to or parallel to the car door. This kind of construction is advantageous because it permits the user to easily grab the handle and move the car door.

However, when the handle presents such a protruding form it becomes challenging to include the electric device for actuating the car door on or near the handle.

There is a lack of space, and a common solution is to separate the electric device from the handle and install the electric device next to the handle under the form of a touch button, for example.

This solution is not ideal as the user needs to realize two tasks to actuate the door: touch the button and grab the handle.

The present disclosure aims to solve all or some of the disadvantages mentioned above among others.

### SUMMARY

This section provides a general summary of the disclosure and is not a comprehensive disclosure of its full scope or all of its features.

For this purpose, the present disclosure relates to a handle for a car door including: a near field communication unit having a microchip and an antenna, the antenna including a coil and an elongated connection part configured for cooperating with the microchip; a body configured to be fixed on the car door, the body presenting a reception area configured to receive the antenna; and an overmolded portion formed on the body and defining an encapsulating zone including entirely the coil and partially the elongated connection part, the elongated connection part including a terminal portion including a cooperation extremity configured to cooperate with the microchip, the terminal portion being outside the encapsulated zone.

Here, the near communication field unit is constructed with distinct parts that are linked but located at different places. The coil in its entirety and the elongated connection part partially are located within the encapsulating zone. The terminal portion and the microchip are outside the encapsulating zone.

This provision is advantageous because it provides that the microchip is located remotely from the measuring location that is near the coil. The microchip is protected for example from humidity. The handle can present various external forms and can be thin, the coil occupying little space. The coil as a detection part can then be advantageously located for an easy actuating.

The coil and the elongated connection part also present a reduced thickness: they are easy to place on the body. They are not particularly delicate so that adding the overmolded portion do not cause any damage on the near field communication unit.

There is therefore more freedom for defining the external form of the handle by the combination of the body and the overmolded portion. The handle can present a gripping side with a limited thickness.

The near field communication unit is configured to communicate or exchange data with a near field communication pass owned by a user of the car. The communication of data permits to open the door of the car, lock or unlock the door.

The body is, for example, made in PBT. The overmolded portion can be made in PC/ABS.

According to an aspect of the disclosure, the handle also includes metal covering layer formed on the overmolded portion and/or on the body, the overmolded portion presenting a free external area in front of the coil according to a winding axis of the coil so as to permit near field communication exchanges.

In other words, provided that there is a free external area, the handle can have a metal covering layer. This metal covering layer can be a decoration.

By free external area, it has to be understood that no element susceptible to reduce the efficiency of near filed communication is located on the free external area. In particular, the metal covering layer does not extend on the free external area.

Elements as plastic can still be added on the free external area because they do not disturb near field communication exchanges. A painting layer can also be added to the free external area.

According to a possibility, the free external area can present a unique area item with a closed contour as a rectangle, possibly with rounded angles. Other forms are also possible.

According to another possibility, the free external area can present several area items, each item being defined by its own contour. Thus, the free external area can have a decorative aspect. A logo or an inscription can be created.

According to an aspect of the disclosure, the metal covering layer is a chromed layer.

This provision permits to have a handle provided with a chromed layer on the exterior and also with a near field communication unit. This chromed layer might be created by a galvanic process, as explained below.

According to a first possibility, the antenna is constituted by a copper wire forming the coil and the elongated connection part, the wire including two extremities configured to be welded to the microchip or to the printed circuit board.

According to this possibility, the elongated connection part is constituted of two parallel fractions of the cooper wire and the coil is a winding. The winding can be a joined winding, or each loop can be spaced from the adjacent one by for example a 0.5 mm gap. The copper wire can have a 0.2 mm diameter and the winding can have a thickness of 3 mm.

According to a second possibility, the antenna is constituted by a copper wire forming the coil and the elongated connection part and a neutral material frame supporting the coil and/or the elongated connection part.

The neutral material frame is in a material that has no electrical propriety, for example in resin. The neutral material frame serves as a holder for maintaining in position the coil. For example, 0.5 mm gap can be set between each adjacent loop of the coil. Also here, the copper wire can have a 0.2 mm diameter and the winding can have a thickness of 3 mm.

According to a third possibility, the antenna is constituted by a flexible printed circuit board including a substrate and conductive tracks defining the coil and the elongated connection part.

The cooperation extremity of the elongated connection part has two terminals configured to cooperate with the microchip, for example by a welding.

This provision simplifies the manufacturing of the handle because the printed circuit board can easily be added on the body.

According to an aspect of the disclosure, the reception area for the antenna is a trench made in the body.

This provision facilitates the positioning of the antenna within the reception area.

According to an aspect of the disclosure, the body includes a bridge configured to cooperate with a superior edge of the car door extending according to a basis plane, the body also including a foot linked to the bridge and located in an interior side of the car with respect to the superior edge, a rigid printed circuit board of the handle being mounted on the foot, the rigid printed circuit board supporting the microchip. Alternatively, the rigid printed circuit board can be located in an external box, which can be placed at any position inside the door.

The position of the foot permits to protect the microchip of the antenna. The foot includes a cover for protecting the rigid printed circuit board.

According to an aspect of the disclosure, the body includes a wing linked to the bridge and located in an exterior side of the car with respect to the superior edge, the reception area being located partially on the wing, in particular for receiving the coil.

As the microchip is not located on the wing of the handle that is manipulated by the user, the wing can be thin.

According to an aspect of the disclosure, the wing extends obliquely to or in parallel to the basis plane. This facilitates the grabbing of the handle. The bridge and the handle can form an elbow.

The present disclosure also concerns a method for manufacturing of a handle for a car door as detailed above, including the following steps: providing the body; then positioning the antenna in the reception area of the body; then installing the body in a mold, the mold presenting a passage opening for inserting the terminal portion outside of a molding area, the passage opening being arranged to be tight when the terminal portion is inserted; and then creating the overmolded portion by injection within the molding area.

This provision permits to obtain an antenna almost entirely fit between the body and the overmolded portion. Only the terminal portion remains outside the overmolded portion so that it can be fixed to the microchip.

In one optional form, after creating the overmolded portion, there is a step of fixing the cooperation extremity of the terminal portion to the microchip. In particular, the cooperation extremity is welded to the microchip or to the printed circuit board.

According to an aspect of the disclosure, the method for manufacturing further includes: a step of fixing the cooperation extremity of the terminal portion to the microchip, in particular by welding; and a step of coating the overmolded portion and/or on the body with a metal covering layer.

The microchip is distant from the metal covering layer. Thus, it becomes possible to make a thin overmolded portion with a metal covering layer.

Alternatively, the metal covering layer can be glued.

According to an aspect of the disclosure, the step of coating includes applying an ink for inhibiting galvanic process on the free external area and then includes forming the metal covering layer via a galvanic process.

It is thus possible to add to the handle a metal covering layer while leaving a free external area to assure good antenna functionality.

The different aspects defined above that are not incompatible can be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a detail of a body and an antenna of a handle according to the teachings of the present disclosure;

FIG. 2 is a front view of the handle of FIG. 1, wherein the antenna is visible by transparency for ease of illustration;

FIG. 3 is an exploded perspective view of the body and the antenna of the handle of FIG. 1;

FIG. 4 is a perspective view of the handle of FIG. 1 installed on a car door according to the teachings of the present disclosure;

FIG. 5 is a perspective view of the rear of the body of FIG. 1, schematically representing a passage opening of a mold for maintaining a terminal portion of the antenna outside an overmolded portion of the handle according to the teachings of the present disclosure; and

FIG. 6 is a flow-chart diagram representing the steps of a method for manufacturing the handle of FIG. 1 according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description of the figures defined above, the same elements or the elements that are fulfilling identical functions may retain the same references so as to simplify the understanding of the invention.

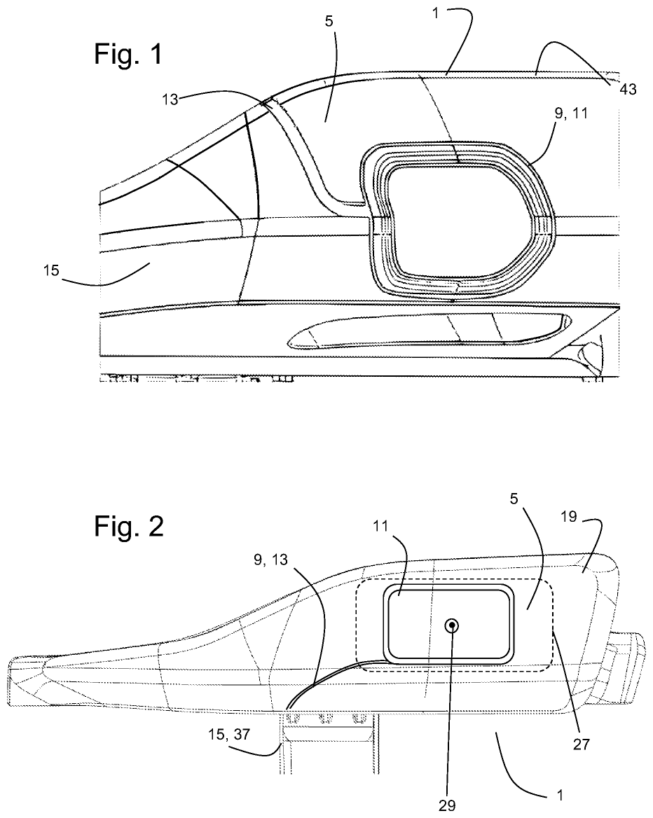

As illustrated in FIGS. 1 to 5, a handle 1 for a car door 3 includes a near field communication unit 5 having a microchip 7 and an antenna 9, the antenna 9 including a coil 11 and an elongated connection part 13 configured for cooperating with the microchip 7.

The handle 1 includes a body 15 configured to be fixed on the car door 3, the body 15 presenting a reception area 17 configured to receive the antenna 9.

The handle 1 also includes an overmolded portion 19 formed on the body 15 and defining an encapsulating zone including entirely the coil 11 and partially the elongated connection part 13.

As shown on FIG. 5, the elongated connection part 13 includes a terminal portion 21 including a cooperation extremity 23 configured to cooperate with the microchip 7, the terminal portion 23 being outside the encapsulated zone.

Here, the near communication field unit 5 is constructed with distinct parts that are linked but located at different places. The coil 11 in its entirety and the elongated connection part 13 partially are located within the encapsulating zone. The terminal portion 23 and the microchip 7 are outside the encapsulating zone.

The near field communication unit 5 is configured to communicate or exchange data with a near field communication pass owned by a user of the car. The communication of data permits to open the door of the car, lock or unlock the door.

The body 15 is for example made in PBT. The overmolded portion 19 can be made in PC/ABS.

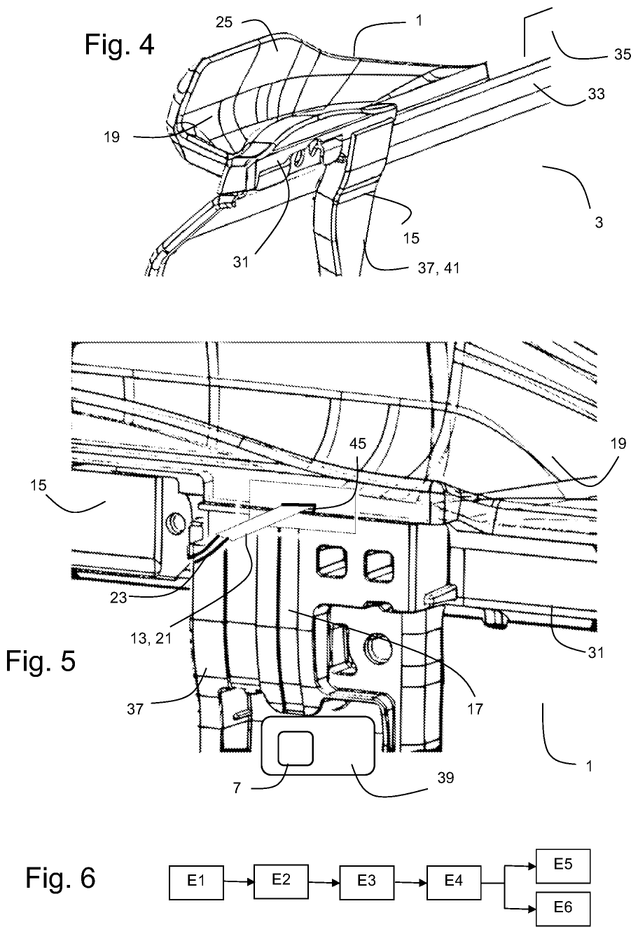

The handle 1 includes a metal covering layer 25 formed on the overmolded portion 19 and/or on the body 15 as depicted on FIG. 4.

The overmolded portion 19 presents a free external area 27 in front of the coil 11 according to a winding axis 29 of the coil 11 so as to permit near field communication exchanges.

In other words, provided that there is a free external area 27, the handle 1 can have a metal covering layer 25. This metal covering layer 25 can be a decoration.

By free external area 27, it is understood that no element susceptible to reduce the efficiency of near filed communication is located on the free external area 27. In particular, the metal covering layer 25 does not extend on the free external area 27.

Elements as plastic can still be added on the free external area 27 because they do not disturb near field communication exchanges. A painting layer can also be added to the free external area 27.

The free external area 27 can present a unique area item with a closed contour as a rectangle, possibly with rounded angles. Other forms are also possible.

According to another possibility, the free external area 27 can present several separated area items, each item being defined by its own contour. It thus appears that the free external area 27 can have a decorative aspect. A logo or an inscription can be created.

Here, the metal covering layer 25 is a chromed layer. This chromed layer might be created by a galvanic process as explained below.

According to a first possibility depicted on FIG. 2, the antenna 9 is constituted by a copper wire forming the coil 11 and the elongated connection part 13, the wire including two extremities configured to be welded to the microchip 7 or to the printed circuit board 39.

According to this possibility, the elongated connection part 13 is constituted of two parallel fractions of the cooper wire and the coil 11 is a winding. The winding can be a joined winding, or each loop can be spaced from the adjacent one by for example a 0.5 mm gap. The copper wire can have a 0.2 mm diameter and the winding can have a thickness of 3 mm.

According to a second possibility depicted on FIG. 1, the antenna 9 is constituted by a copper wire forming the coil 11 and the elongated connection part 13 and a neutral material frame supporting the coil 11 and/or the elongated connection part 13.

The neutral material frame is in a material that has no electrical propriety, for example in resin. The neutral material frame serves as a holder for maintaining in position the coil 11. For example, 0.5 mm gap can be set between each adjacent loop of the coil 11. Also here, the copper wire can have a 0.2 mm diameter and the winding can have a thickness of 3 mm.

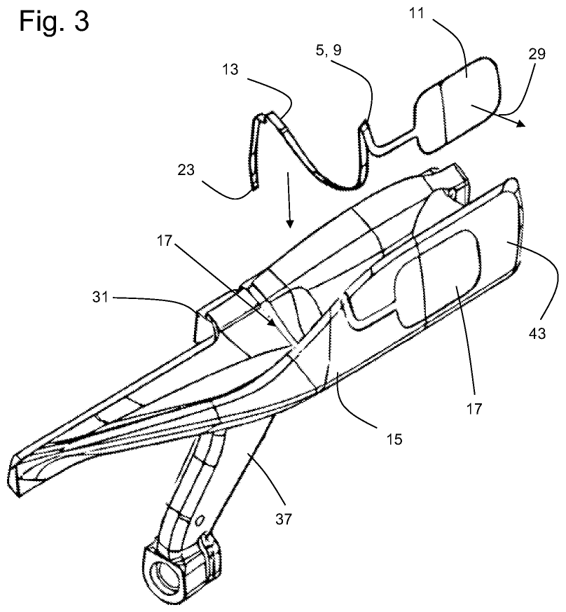

According to a third possibility depicted on FIG. 3, the antenna 9 is constituted by a flexible printed circuit board including a substrate and conductive tracks defining the coil 11 and the elongated connection part 13.

More generally, the cooperation extremity 23 of the elongated connection part 13 has two terminals configured to cooperate with the microchip 7, for example by a welding.

The reception area 17 for the antenna is a trench made in the body 15.

As illustrated in FIGS. 3 to 5, the body 15 includes a bridge 31 configured to cooperate with a superior edge 33 of the car door 3 extending according to a basis plane 35, the body 15 also including a foot 37 linked to the bridge 31 and located in an interior side of the car with respect to the superior edge 33.

As shown on FIG. 5, a rigid printed circuit board 39 of the handle 1 is mounted on the foot 37, the rigid printed circuit board 39 supporting the microchip 7.

The position of the foot 37 permits to protect the microchip 7 of the antenna 9. The foot 37 includes a cover 41 for protecting the rigid printed circuit board 39.

The body 15 includes a wing 43 linked to the bridge 31 and located in an exterior side of the car with respect to the superior edge 33, the reception area 17 being located partially on the wing 43, among other things for receiving the coil 11.

As the microchip 7 is not located on the wing 43 of the handle 1 that is manipulated by the user, the wing 43 can be thin.

The wing 43 extends obliquely to or in parallel to the basis plane 35. This facilitates the grabbing of the handle 1. The bridge 31 and the handle 1 can form an elbow.

As illustrated on FIG. 6, a method for manufacturing of a handle 1 for a car door 3 as described above includes the following steps:

At E1, providing a body 15.

Then, at E2, positioning the antenna 9 in the reception area 17 of the body 15.

Then, at E3, installing the body 15 in a mold, the mold presenting a passage opening 45 represented in FIG. 5 for inserting the terminal portion 21 outside of a molding area, the passage opening 45 being arranged to be tight when the terminal portion 21 is inserted.

Then, at E4, creating the overmolded portion 19 by injection within the molding area.

Then, at E5, fixing the cooperation extremity 23 of the terminal portion 21 to the microchip 7. In particular, the cooperation extremity 23 is welded to the microchip 7 or to the printed circuit board 39.

At E6, coating the overmolded portion 19 and/or on the body 15 with a metal covering layer 25.

The step E6 of coating includes applying an ink for inhibiting galvanic process on the free external area 27 and then includes forming the metal covering layer via a galvanic process.

Alternatively, the metal covering layer 25 can be glued.

The above-described handle 1 is advantageous because it provides that the microchip 7 is located remotely from the measuring location that is near the coil 11. The microchip 7 is protected for example from humidity. The handle 1 can present various external forms and can be thin, the coil 11 occupying little space. The coil 11 as a detection part can then be advantageously located for an easy actuating.

There is therefore more freedom for defining the external form of the handle 1 by the combination of the body 15 and the overmolded portion 19. The handle 1 can present a gripping side with a limited thickness.

It is understood that the invention is not limited to the sole form described above by way of example, it encompasses all the variants.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. Handle for a car door comprising:
a near field communication unit including a microchip and an antenna, the antenna including a coil and an elongated connection part configured for cooperating with the microchip,
a body configured to be fixed on the car door, the body presenting a reception area configured to receive the antenna,
an overmolded portion formed on the body and defining an encapsulating zone including an entirety of the coil and part of the elongated connection part, the elongated connection part comprising a terminal portion including a cooperation extremity configured to cooperate with the microchip, the terminal portion being outside the encapsulated zone.

2. The handle according to claim 1, further comprising a metal covering layer formed on the overmolded portion and/or on the body, the overmolded portion presenting a free external area in front of the coil according to a winding axis of the coil so as to permit near field communication exchanges.

3. The handle according to claim 2, wherein the metal covering layer is a chromed layer.

4. The handle according to claim 1, wherein the antenna is constituted by a copper wire forming the coil and the elongated connection part, the wire comprising two extremities configured to be welded to the microchip or to the printed circuit board.

5. The handle according to claim 1, wherein the antenna is constituted by a copper wire forming the coil and the elongated connection part and a neutral material frame supporting the coil and/or the elongated connection part.

6. The handle according to claim 1, wherein the antenna is constituted by a flexible printed circuit board including a substrate and conductive tracks defining the coil and the elongated connection part.

7. The handle according to claim 1, wherein the reception area for the antenna is a trench made in the body.

8. The handle according to claim 1, wherein the body comprises a bridge configured to cooperate with a superior edge of the car door extending according to a basis plane, the body also including a foot linked to the bridge and located in an interior side of the car with respect to the superior edge, a rigid printed circuit board of the handle being mounted on the foot, the rigid printed circuit board supporting the microchip.

9. The handle according to claim 8, wherein the body comprises a wing linked to the bridge and located in an exterior side of the car with respect to the superior edge, the reception area being located partially on the wing, in particular for receiving the coil.

10. A method for manufacturing of a handle for a car door according to claim 1, the method comprising the following steps:
(E1) providing the body;
(E2) after step (E1), positioning the antenna in the reception area of the body;
(E3) after step (E2), installing the body in a mold, the mold presenting a passage opening for inserting the terminal portion outside of a molding area, the passage opening being arranged to be tight when the terminal portion is inserted; and
(E4) after step (E3), creating the overmolded portion by injection within the molding area.

11. The method according to claim 10, further comprising the following steps:
(E5) fixing the cooperation extremity of the terminal portion to the microchip by welding; and
(E6) coating the overmolded portion and/or on the body with a metal covering layer.

12. The method according to claim 11, wherein the step (E6) of coating includes applying an ink configured to inhibit galvanic process on the free external area and then includes forming the metal covering layer via a galvanic process.
